(19) United States
(12) Patent Application Publication
(10) Pub. No.: US 2012/0124049 A1
(43) Pub. Date: May 17, 2012

(54) PROFILE ANALYSIS SYSTEM

(75) Inventors: Takayuki AKIYAMA, Kokubunji (JP); Shintaro IRISA, Yokohama (JP)

(73) Assignee: HITACHI SOLUTIONS, LTD., Tokyo (JP)

(21) Appl. No.: 13/293,376

(22) Filed: Nov. 10, 2011

(30) Foreign Application Priority Data
Nov. 11, 2010 (JP) 2010-252784

(51) Int. Cl. G06F 17/30

(52) U.S. Cl. 707/737; 707/736; 707/E17.005; 707/E17.089

(57) ABSTRACT

To recommend information useful for a user regardless of domains and services, items are defined by basic desires as action objectives of the user, a user profile is expressed by basic desire strengths, constant strengths of the desires of the user calculated from an action history of the user are compared with current desire strengths, current desire degrees are calculated, and recommended items are presented.

### CLAIM OF PRIORITY

The present application claims priority from Japanese patent application JP 2010-252784 filed on Nov. 11, 2010, the content of which is hereby incorporated by reference into this application.

### BACKGROUND OF THE INVENTION

1. Field of the Invention

The present invention relates to an apparatus that extracts and analyzes information related to characteristics of a user.

2. Background Art

An amount of information provided by various media, such as the Internet, is overwhelming due to the development of information communication techniques and the proliferation of commercial uses of the techniques. The user can receive various pieces of information, and the utility of the information for the user is diversified. Therefore, it is difficult for the user to select useful information for the user from a large amount of various pieces of information. Advantages of advertising to an unspecified number of individuals are decreasing for information providers. Under the circumstances, recently known techniques include a technique of recommending useful information suitable for a profile of the user by extracting and analyzing a profile such as preference information (what kind of information the user is interested in) of the user from an action history of the user and a data mining technique for using the profile as marketing data in targeting advertising.

In a conventional profile analysis technique, an action history of the user is stored in each service, and a profile is written by an original management method and is used in a recommendation process. For example, in a TV program recommendation system, a viewing history of TV programs of the user is written by words included in the programs, such as categories (variety, sports, etc.) and casts of the TV programs. Frequencies of appearance of the words in the viewing history are extracted as preference information of the user, and the information is used for recommendation of programs. In a commodity recommendation system often seen in EC sites, a commodity purchase history of the user is used to recommend commodities purchased by users who have purchase histories similar to the purchase history of the user. Therefore, the user profile is extracted only from the use history of the services.

However, a large number of action histories of the user need to be acquired to accurately extract the user profile. Only the action history of a single domain of the user is conventionally used, and the user profile cannot be highly accurately extracted. The domain herein denotes a range of content limited by categories for providing content, such as “TV program”, “movie”, and “travel”. This indicates that the features of the user cannot be highly accurately specified just by the viewing actions of TV programs. Even if action histories across a plurality of domains are acquired, the description systems of histories of the domains are different in the conventional technique, and a versatile user profile across a plurality of domains cannot be extracted.

To solve the problem, a Bayesian network model is used in JP 2007-58398A to express the dependency (hereinafter, “common attributes”) between user attributes and item attributes by random variables. The adaptability of items for a specific user is verified for each combination of the specific user and the items based on the values, and items to be recommended to the specific user are determined from the verification result to thereby improve the recommendation accuracy of the items. For example, terms used to evaluate items (for example, movies) are extracted as common attribute candidates based on hearing survey of subject, qualitative research, etc., and candidates commonly supported by most people are selected from the common attribute candidates by a large-scale questionnaire survey, etc., to thereby deliver the random variables of the common attributes. Items recommended to the specific user can be determined based on the random variables.

### SUMMARY OF THE INVENTION

In JP 2007-58398A, there are problems that the dependency of the random variables needs to be set in advance and that the item attributes are specialized to each domain.

The present invention has been made in view of the foregoing circumstances, and an object of the present invention is to provide a system that can recommend information useful for a user regardless of the domain.

To solve the problems, a profile analysis system of the present invention defines items by basic desires as action objectives of the user, expresses a user profile by basic desire strengths, compares constant strengths of desires of the user calculated from an action history of the user with current desire strengths, and calculates current desire degrees to present recommended items.

The present invention provides a profile analysis system including: a user action history database that stores information related to an item selection history of a user; a user profile database that stores, as a desire profile of the user, information of constant desire strengths of the user for basic desires of a plurality of types; an item database that stores information related to a correspondence between items and the types of the basic desires; a desire satisfaction degree calculation unit that calculates desire satisfaction degrees for the basic desires of the user from the item selection history stored in the user action history database; a desire calculation unit that calculates current basic desire strengths of the user from the desire satisfaction degrees and the desire profile; and a recommendation unit that recommends items suitable for the current basic desire strengths of the user from the item database based on the current basic desire strengths of the user and the correspondence between the items and the types of the basic desires. In this way, the description of the user profile and the items by the basic desires allows unified handling of different types of items provided by various services and appropriate recommendation of items that the user currently needs.

According to the present invention, a user can obtain information optimal for action objectives of the user from a wide variety of fields, and living activities are enriched. An information provider can provide services that do not bore the user.

Other problems, configurations, and effects will become more apparent from the description of the following embodiments.

### BRIEF DESCRIPTION OF THE DRAWINGS

FIG. 1 is a block diagram of a system with a function of recommending items from analysis of a profile and a result of the analysis according to an embodiment of the present invention.

FIG. 2 is a diagram showing an example of configuration of data stored in a user action history database.

FIG. 3 is a diagram showing an example of configuration of data stored in a user profile database.

FIG. 4 is a diagram showing an example of configuration of data stored in an item database.

FIG. 5 is a flow chart showing a summary of a process.

FIG. 6 is a diagram showing an example of configuration of a profile analysis system with an improved function of a constant desire degree.

FIG. 7 is a flow chart showing a flow of a process in a profile analysis system with an improved function of the constant desire degree.

FIG. 8 is a block diagram of a system showing a relationship between databases and desire analysis.

FIG. 9 is a schematic diagram explaining a system of learning desire profiles.

FIG. 10 is a schematic diagram explaining a system of learning desires for items.

FIG. 11 is a flow chart showing a flow of learning desires for items.

FIG. 12 is a data block diagram providing a probability table to cluster groups of items.

FIG. 13 is an explanatory view of a system for learning unknown desires for items and desire profiles of unknown users.

FIG. 14 is a flow chart showing a flow of learning desires for unknown items and desire profiles of unknown users.

FIG. 15 is a diagram showing an example of system configuration of an embodiment including a plurality of item databases in different domains.

FIG. 16 is a diagram showing an example of data configuration of a user action history database of the embodiment including a plurality of item databases in different domains.

FIG. 17 is a diagram showing an example of data configuration of an item database of the embodiment including a plurality of item databases in different domains.

FIG. 18 is a flow chart showing a flow until items are presented in a system including a plurality of item databases in different domains.

FIG. 19 is a diagram showing an example of configuration of a system with a function of selecting an item database used for recommendation from a plurality of item databases in different domains.

FIG. 20 is a flow chart showing a flow of a process in a system with a function of selecting an item database used for recommendation from a plurality of item databases in different domains.

FIG. 21 is a diagram showing an example of configuration of a system with a function of connecting to individual services.

FIG. 22 is a diagram showing an example of data configuration of a user action history database of the system with the function of connecting to individual services.

FIG. 23 is a diagram showing an example of data configuration of a user profile database of the system with the function of connecting to individual services.

FIG. 24 is a flow chart showing a flow of a process in the system with the function of connecting to individual services.

### DETAILED DESCRIPTION OF THE PREFERRED EMBODIMENTS

Nelson P.: “Information and Consumer Behavior”, Journal of Political Economy, Vol. 78, pp. 311-329, (1970) suggests that an object of a consumption behavior of human being is to satisfy a desire. The existence of basic desires of human being is known as shown in Steven Reiss: “Who am I? The 16 Basic desires that Motivate Our Actions and Define Our Personalities”, Berkley Trade (2002). Desire strengths in consumption behaviors of the user can be expressed by constant strengths of desires that are universal in the long term and momentary strengths based on satisfaction degrees of desires in the short term (hereinafter, “current desires”).

Examples of the basic desires include “possession”, “intellectual curiosity”, “peace of mind”, and “social belonging”. “Possession” is a desire related to acquisition and possession, such as collection of goods and possession of special things. “Intellectual curiosity” is a desire related to curiosity to knowledge, such as interest in unknown things and learning unknown matters. “Peace of mind” is a desire related to calmness of mind, such as healing, release from stress, and prevention of shame. “Social belonging” is a desire related to a sense of belonging to society, such as protection of regions or society and doing right things on a global scale. For example, the desire of “possession” emerges in a plurality of domains, such as collection of stamps, recording of series TV programs, a bonus gift of drinking water, and local gourmet. The desire of “intellectual curiosity” emerges in a plurality of domains, such as watching an educational program, purchasing a book related to trivia, and a historic site tour. The desire of “peace of mind” emerges in actions of a plurality of domains, such as programs or CDs of classic concerts, purchase of commodities related to aromatherapy, and a hot spring trip. The desire of “social belonging” emerges in a plurality of domains, such as watching sports programs in which countries are represented as in the Olympics and purchase of commodities with small environmental load.

A profile analysis system of the present invention defines items by basic desires as action objectives of the user, expresses a user profile by basic desire strengths, compares constant strengths of desires of the user calculated from an action history of the user with current desire strengths, and calculates current desire degrees to present recommended items suitable for the desires.

Hereinafter, embodiments for carrying out the present invention will be described in detail with reference to the drawings.

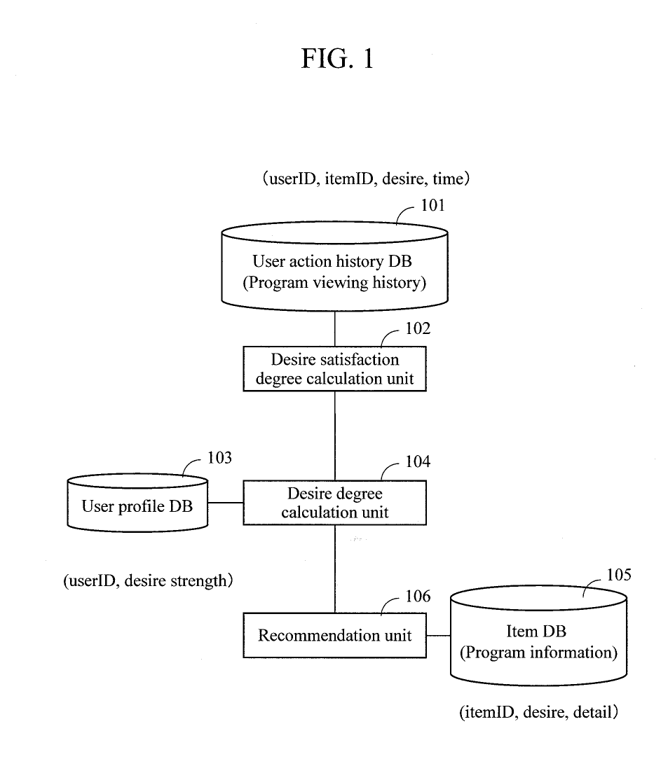

FIG. 1 is a diagram showing an example of system configuration of an embodiment of the present invention. The profile analysis system of the present embodiment is a system that has a function of recommending TV programs based on analysis of profiles and a result of the analysis. The present system includes a user action history database 101 that stores information related to a viewing history of TV programs, a desire satisfaction degree calculation unit 102 that calculates desire satisfaction degrees from the user action history database 101, a user file database 103 that stores a desire profile as information indicating characteristics of the basic desires of the user, a desire degree calculation unit 104 that calculates current desire strengths from the desire satisfaction degree calculation unit 102 and the user profile database 103, an item database 105 that stores information indicating what kinds of basic desires the recommended TV programs satisfy or indicating based on what kinds of basic desires the target TV programs are generally watched, and a recommendation unit 106 that recommends TV programs suitable for the current desires of the user from the desire degree calculation unit 104 and the item database 105. The desires here denote basic desires as behavioral principles of human being represented by intellectual curiosity, desire for possession, desire for social belonging, etc.

FIG. 2 is a diagram showing an example of configuration of data stored in the user action history database 101. The diagram includes a user ID 201 for uniquely identifying the user, an item ID 202 for uniquely identifying the TV program, a desire ID 203 indicating the type of the basic desire satisfied by watching the TV program, and date/time 204 of watching the program.

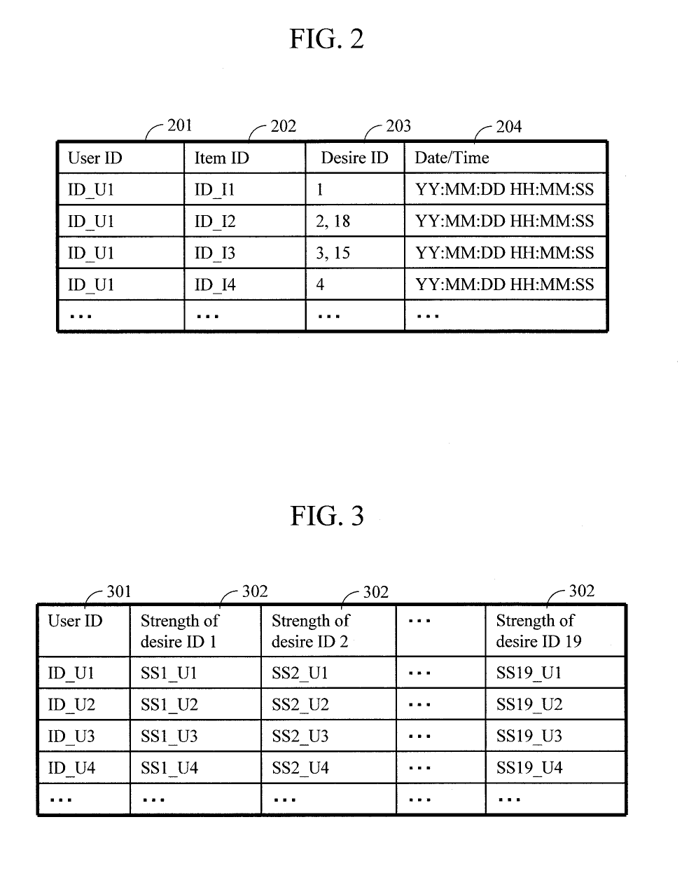

FIG. 3 is a diagram showing an example of configuration of user profile data stored in the user profile database 103. The diagram includes a user ID 301 for uniquely identifying the user and a strength of desire IDₙ 302 that is a ratio indicating a constant desire degree showing the degree of a basic desire of the user on a daily basis. In the present example, there are 19 types of basic desires ID₁ to ID₁₉. The constant desire strength of the user may be generated by, for example, answering the questionnaire, such as a psychological test, upon the subscription of the service by the user. The user may set the constant desire strength. Since the constant desire degree varies by the seasons, the constant desire degree may be registered season by season. As described later, the constant desire degree may be learned and estimated.

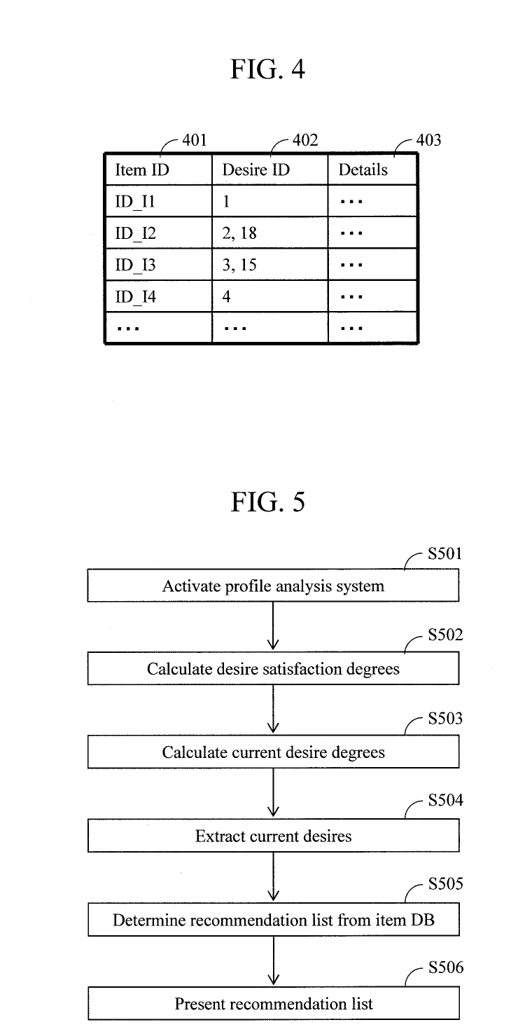

FIG. 4 is a diagram showing an example of configuration of data stored in the item database 105. The diagram includes an item ID 401 for uniquely identifying the TV program, a desire ID 402 indicating the type of the basic desire as a basis of the viewing action of the TV program, and details 403 indicating details of the TV program. The type of the basic desire as a basis of the viewing action of the TV program may be, for example, arbitrarily set by the provider when the service is provided. As described later, the type may be learned and estimated. Information related to the item is stored as text data in the details 403.

FIG. 5 is a flow chart showing a summary of a process in the present embodiment. When the profile analysis system is activated (S501), the desire satisfaction degree calculation unit 102 calculates the desire satisfaction degrees based on the desire information related to the TV program viewing history stored in the user action history database 101 (S502). The desire satisfaction degrees are ratios indicating, basic desire by basic desire, what kinds of basic desires of the target user are satisfied at this moment and what kinds of basic desires are not satisfied. The desire satisfaction degrees are calculated by, for example, the following formula.

$${S}_{n} = \frac{{C}_{n}}{{C}_{total}} \qquad ( 1 )$$

When an arbitrary desire ID is assumed as n, Sₙ, denotes a desire satisfaction degree of the desire IDₙ, Cₜₒₜₐₗ denotes a total number of all actions, and Cₙ denotes the number of times the desire IDₙ is satisfied in the actions. In the case of a TV program, the calculation may be based on the length or viewing time of the program, instead of the number of times. In the case of a commodity other than the TV program, the price, etc., may be used. In that case, for example, Cₜₒₜₐₗ can be the total expense spent by the user, and Cₙ, can be the expense spent for the desire IDₙ.

The desire satisfaction degree is calculated from, for example, the action history of the past one week based on the date/time 204 stored in the user action history database 101. In that case, the user action history database 101 may store only the action history within a period used to calculate the desire satisfaction degree.

For all basic desires, the desire degree calculation unit 104 calculates the current basic desire strengths based on the desire satisfaction degrees and the constant desire degrees stored in the user profile database 103 (S503) to extract the basic desires strongly desired by the user at this moment (S504).

The current basic desire strengths are calculated by, for example, the following formula.

$$\begin{matrix}{Q}_{n} = 1 - \frac{{S}_{n}}{{SS}_{n}} & ( when {S}_{n} \leq {SS}_{n} ) \\ {Q}_{n} = 0 & ( when {S}_{n} > {SS}_{n} )\end{matrix} \qquad ( 2 )$$

In this case, Qₙ denotes a ratio indicating the current strength of the desire IDₙ and is a value between 0 and 1. Sₙ denotes a desire satisfaction degree of the desire IDₙ. SSₙ managed by the user profile database 103 denotes a ratio indicating the constant desire degree of the desire IDₙ and is a value between 0 and 1. If the desire satisfaction degree Sₙ, is greater than the ratio of the constant desire degree SSₙ, the current desire is sufficiently satisfied, and the value of Qₙ, is 0. Other systems may be used for the formula as long as the basic desire strengths can be expressed.

Lastly, TV programs satisfying the basic desires extracted in S504 are extracted from the item database 105 (S505), and the recommended TV programs are presented to the user (S506).

For example, if the strongest basic desire calculated in the current desire extraction process is “intellectual curiosity”, TV programs such as “educational programs” and “quiz programs” that satisfy the basic desires of “intellectual curiosity” are generally recommended. TV programs corresponding to the strongest basic desire among all desire degrees may be selected as the TV programs to be recommended to the user, or TV programs with desire degrees greater than a certain value may be collectively recommended.

An action history of not only watching of programs but also of different domains can also be used. In that case, if the strongest basic desire calculated in the current desire extraction process is “intellectual curiosity”, commodities belonging to different domains, such as “books related to trivia” and “planetarium”, are also recommended in addition to “educational programs” and “quiz programs”.

In relation to the embodiment, a profile analysis system designed to perform more accurate recommendation by improving the constant desire degrees based on the reaction of the user to the recommended TV programs will be described.

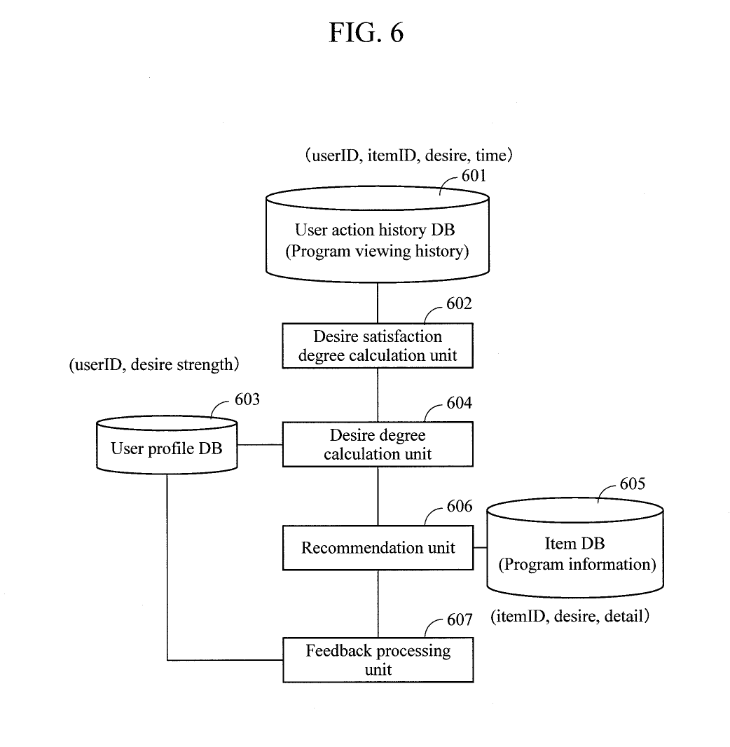

FIG. 6 is a system block diagram indicating an example of configuration of an embodiment of the profile analysis system with an improved function of the constant desire degrees according to the present invention. The system includes a user action history database 601 that stores information related to the action history of the user, a desire satisfaction degree calculation unit 602 that calculates desire satisfaction degrees from the user action history database 601, a user profile database 603 that stores information of constant desire degrees of basic desires, a desire degree calculation unit 604 that calculates current basic desire strengths from the desire satisfaction degree calculation unit 602 and the user profile database 603, an item database 605 that stores information of items corresponding to the basic desires, a recommendation unit 606 that recommends items suitable for the current basic desires of the user from the desire degree calculation unit 604 and the item database 605, and a feedback processing unit 607 that recalculates and improves values of the constant desire degrees of the basic desires used in the recommendation if the user does not select the TV programs recommended by the recommendation unit 606.

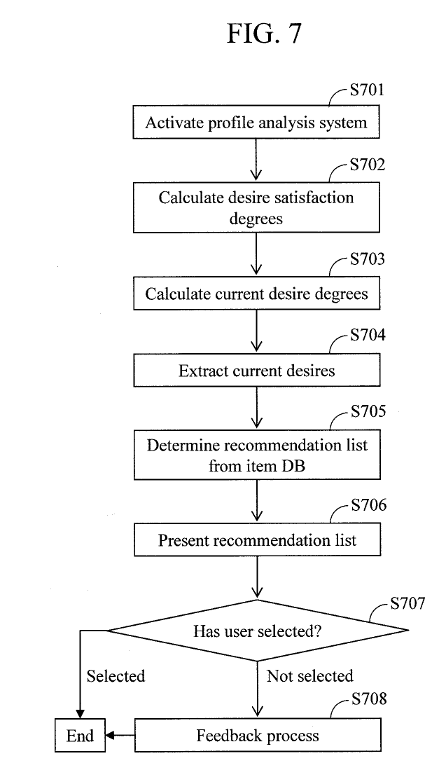

FIG. 7 is a flow chart showing a summary of a process in the profile analysis system including an improved function of the constant desire degrees.

When the profile analysis system is activated (S701), the desire satisfaction degree calculation unit 602 calculates the desire satisfaction degrees based on the desire information related to the TV program viewing history stored in the user action history database 601 (S702). The formula of the desire satisfaction degrees is the same as Expression (1). The desire degree calculation unit 604 calculates the current basic desire strengths of all desires based on the desire satisfaction degrees of the desire IDₙ, and the constant desire degrees stored in the user profile database 603 (S703), and the basic desires strongly desired by the user at this moment are extracted (S704). The formula of the current basic desire strengths is the same as Expression (2). TV programs that satisfy the extracted basic desires are extracted from the item database 605 to determine TV programs to be recommended (S705), and the recommended TV programs are presented to the user (S706). If the user does not watch the recommended TV programs (S707), the constant desire degrees of the basic desires used in the process of extracting the programs to be recommended (S705) are adjusted to be lower, and the adjusted values are stored again in the user profile database 603 (S708). Values after the adjustment of the constant desire degrees are calculated by, for example, the following formula.

$${SS}_{n}^{new} = \frac{{wSS}_{n}^{old}}{1 - ( 1 - w ) {SS}_{n}^{old}} \qquad ( 3 )$$

SSₙ^{new} denotes a value after the adjustment of the constant desire degree of the desire IDₙ. In the formula, w denotes a parameter for determining how much the viewing actions of the user performed in one TV program recommendation will be reflected in the adjustment of the constant desire degree and is a value between 0 and 1. SSₙ^{old} denotes a value before the adjustment of the constant desire degree of the desire IDₙ. Other systems may be used for the formula as long as the feedback to the constant desire degree is possible.

The improved function of the constant desire degrees can be applied to all embodiments of the present invention.

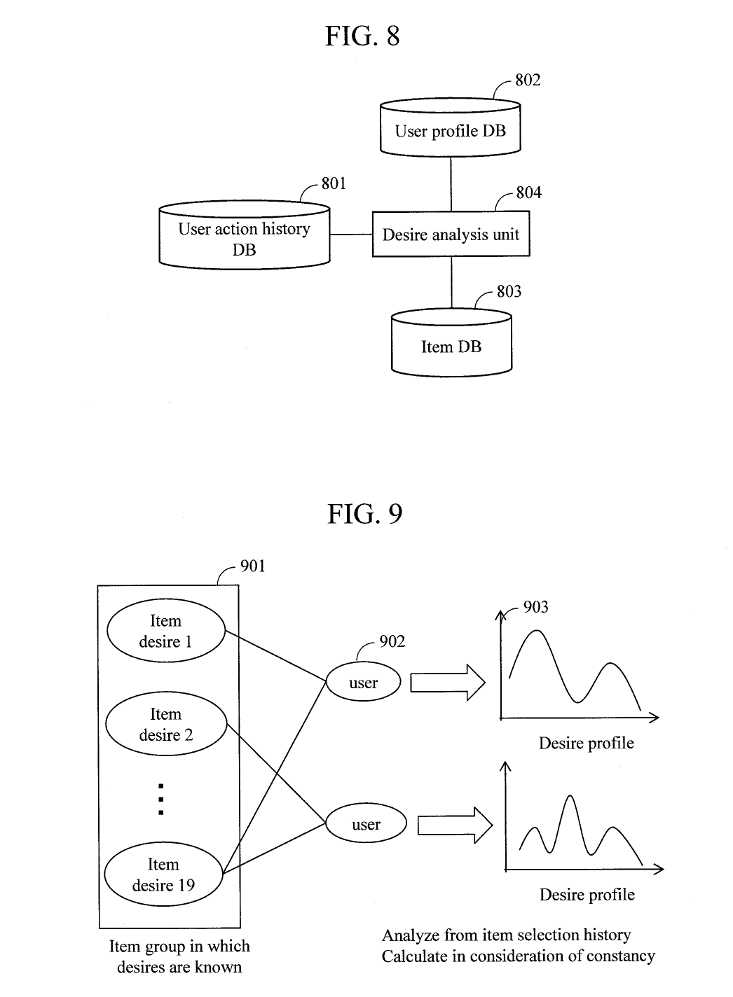

FIG. 8 is a diagram showing an example of configuration of a system for learning basic desires associated with items, such as TV programs registered in the item database, or desire profiles of the users from known information by desire analysis. The system includes a user action history database 801 that stores information related to the action history of the user, a user profile database 802 that stores information of constant desire degrees of basic desires, an item database 803 that stores information of items, such as TV programs, corresponding to the basic desires, and a desire analysis unit 804 that analyzes desire profiles of unknown users or unknown basic desires for the items based on the user action history database 801, the user profile database 802, and the item database 803.

FIG. 9 is a schematic diagram explaining a system of learning the desire profiles of the users when all basic desires for the items are known and all desire profiles of the users are unknown. An item group 901 in which corresponding basic desires are known is information stored in the item database 803. The desire degrees corresponding to the items are extracted from the item selection history of a user 902 whose desire profile is unknown, and a desire profile 903 of the user 902 is created. More specifically, the basic desires corresponding to the items selected by the user 902 are compiled by the types of the basic desires, and the desire degrees of the basic desires are calculated to set the desire profiles 903 of the users. Expression (1) may be used to calculate the desire degrees. The fact that habitual actions are periodically performed can be taken into account in relation to the selection of the item selection history for extracting the desire degrees. Seasonal actions may also be taken into account.

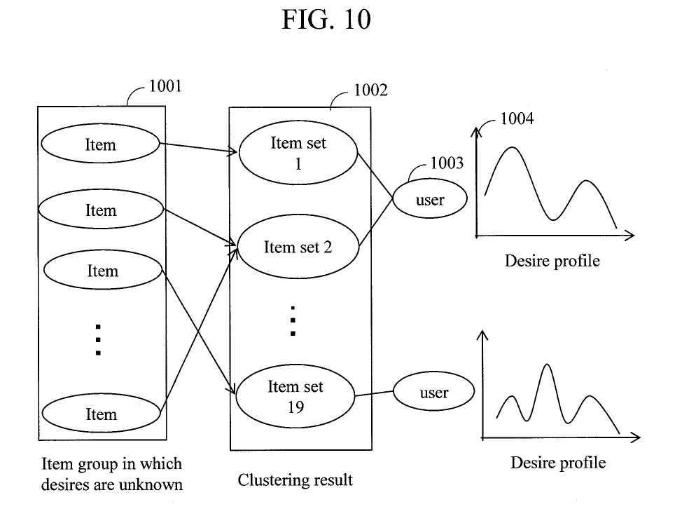

FIG. 10 is a schematic diagram explaining a system of learning basic desires corresponding to items when the desire profiles of the users are known. Similarities between the items are calculated to cluster (group) an item group 1001 in which the basic desires are unknown, and the basic desires are allocated to a clustering result 1002 so as to adapt to desire profiles 1004 of users 1003 based on the clustering result 1002. In this case, one or a plurality of basic desires of the same type are allocated to the items belonging to the item sets.

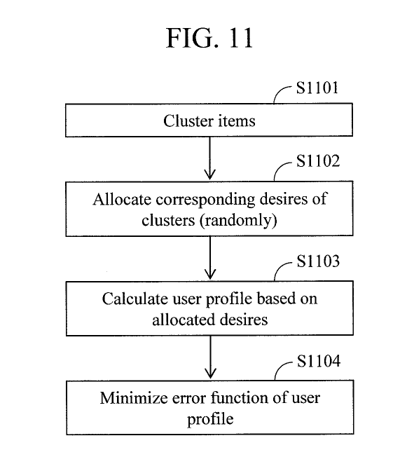

FIG. 11 is a flow chart showing a flow from clustering of items to allocation of basic desires to clusters. Similarities between the items are calculated to cluster the item group 1001 in which the corresponding basic desires are unknown (S1101). For example, the similarities between the items may be based on a method of calculation on the basis of actions of the users as in the following Expression (4) or may be based on the content using the features of the items as in the following Expression (5). Other methods for expressing the similarities between the items may also be used.

d(Iₙ,Iₘ)=P(Iₙ,Iₘ) (4)

Iₙ denotes an item in which the item ID is n, and d(Iₙ, Iₘ) denotes a similarity between the items Iₙ and Iₘ. P(Iₙ, Iₘ) denotes the number of users who have used both the items Iₙ and Iₘ.

$$d ( {I}_{n} , {I}_{m} ) = \frac{1}{{\sum }_{i} \vert {I}_{n} ( i ) - {I}_{m} ( i ) \vert} \qquad ( 5 )$$

In the formula, i denotes a word included in the detailed information of the item. Iₙ(i) indicates whether the word i is included, and Iₙ(i) may be a value of two types, 0 or 1, or may be the number of appearances of the word.

A conventional method, such as hierarchical clustering and k-means, is used for the clustering method, and the format allows duplications in the clusters. The basic desires are randomly set for the clusters generated by the method (S1102). The desire profile 1004 that is calculated when each user selects the cluster is calculated based on the basic desire allocated to the cluster, and the desire profile 1004 is compared with the desire profile of the known user to calculate a degree of adaptability of the basic desire (S1103). The calculation of the desire profile may be obtained as a result of the calculation of Expressions (1) and (2) for all basic desires. The degrees of adaptability of the basic desires are calculated by, for example, the following formula.

$$R ( {G}_{k} , {D}_{i} ) = {\sum }_{n} {( {Ui}_{n} ( {G}_{k} , Di ) - {U}_{n}^{true} ( {D}_{i} ) )}^{2} \qquad ( 6 )$$

Gₖ denotes a cluster, and R (Gₖ, Dᵢ) denotes a degree of adaptability between the cluster Gₖ and the allocated basic desire Dᵢ. Uiₙ (Gₖ, Dᵢ) denotes a strength of the basic desire Dᵢ generated from the history of the user n using the cluster Gₖ, and Uₙ^{true}(Dᵢ) denotes a strength of the basic desire Dᵢ of the desire number i of the desire profile of the user n. Other formulas may also be used as long as the degrees of adaptability are expressed.

The degrees of adaptability of the basic desires corresponding to the clusters are adjusted to minimize an error function such as the following Expression (7) to learn the basic desires corresponding to the clusters randomly allocated in S1102 (S1104).

$$E = {\sum }_{k , i} {( R ( {G}_{k} {D}_{i} ) )}^{2} \qquad ( 7 )$$

Systems other than Expression 7 may be used as the error function as long as the degrees of adaptability of the basic desires are adjusted.

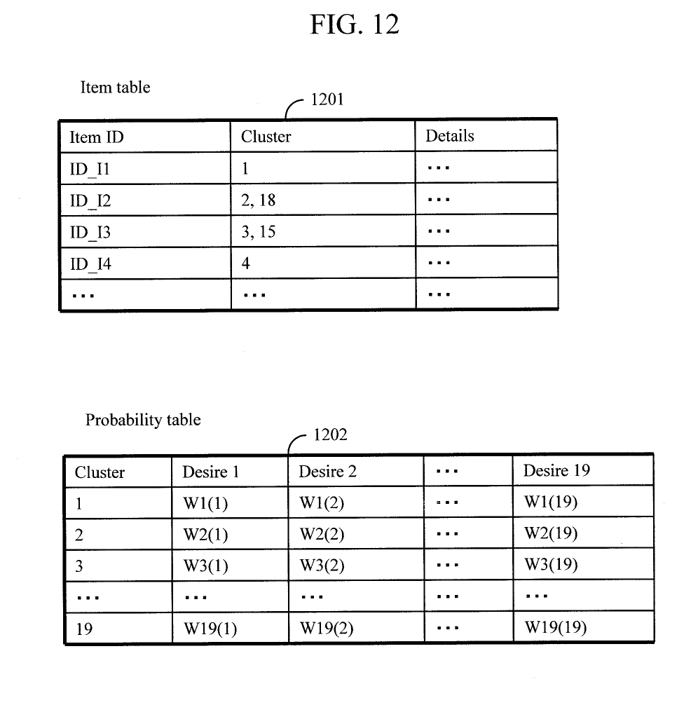

A genetic algorithm, a steepest descent method, etc., can be used as the minimization method. Alternatively, probability values corresponding to the basic desires may be provided to the clusters to adjust the probability. FIG. 12 is a data block diagram provided with a probability table. The diagram includes an item table 1201 that stores relationships between the items and clusters and a probability table 1202 that stores probabilities of the basic desires of the clusters. The probabilities are adjusted based on the probability values. The degrees of adaptability of the basic desires corresponding to the clusters shown in Expression (7) can be minimized to adjust the probabilities.

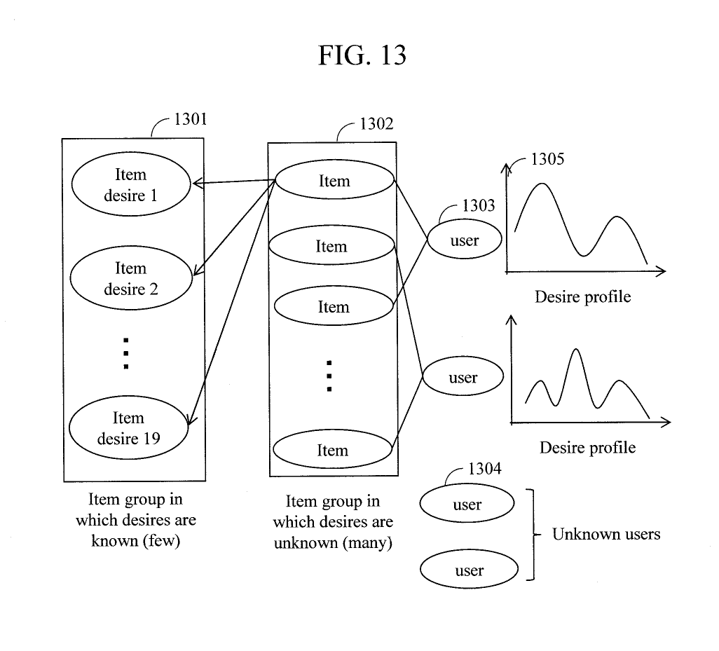

FIG. 13 is a schematic diagram explaining a system of learning a large number of items not associated with the types of the basic desires and desire profiles of the users in which the desire profiles are unknown, when the types of the basic desires corresponding to part of the items and the desire profiles of part of the users are known. A similarity between an item group 1301 in which corresponding basic desires are known and an item group 1302 in which corresponding basic desires are unknown is calculated, and the basic desires of the items in which the basic desires are unknown are set as the same as the basic desires corresponding to the basic desires of the items with high similarity in which the basic desires are known. The desire profiles of users 1303 in which the desire profiles are known are calculated as described above based on the set basic desires of the items, and the desire profiles are compared with the known desire profiles to adjust the basic desires corresponding to the items to more accurate basic desires. Desire profiles are created from action histories of users 1304 in which the desire profiles are unknown, and users with high similarity are specified from the action histories of the users in which the desire profiles are known to further learn the basic desires of the items.

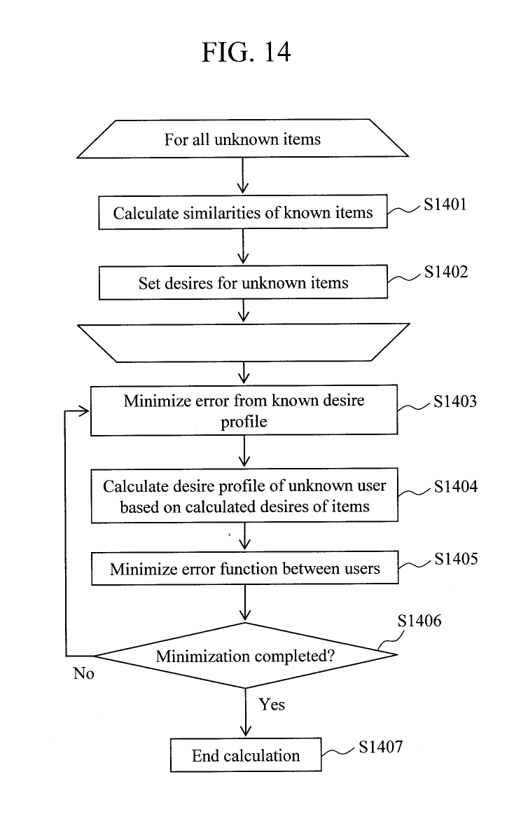

FIG. 14 is a flow chart showing a flow until the association of basic desires with unknown desire profiles and with unknown items.

For an item in which the relationship with a basic desire is unknown, similarities with all items in which the relationship with the basic desire is known are calculated (S1401). The similarities can be calculated using Expression (4) or (5). The basic desires of the items in which corresponding basic desires are unknown are set as the same basic desires as the basic desires corresponding to the known items with high calculated similarity (S1402). S1401 and S1402 are executed for all items in which the basic desires are unknown.

User profiles 1305 of the known users 1303 are calculated from the action histories of the users in which the desire profiles are known based on the basic desires of the calculated items, and probability values for the basic desires set for the items are adjusted to minimize the error function of Expression (6) (S1403). The basic desires of the items in which the calculated basic desires are unknown and the basic desires of the items in which the basic desires are known are used to calculate the desire profiles of the users in which the desire profiles are unknown (S1404). The desire profiles may be obtained as a result of the calculation of Expressions (1) and (2) for all basic desires. For the desire profiles of the users in which the calculated desire profiles are unknown, the users in which the desire profiles with high similarity: are known are specified from the action histories of the users in which the desire profiles are known and the action histories of the target users, and an adjustment is made based on, for example, an error function shown in the following Expression (8) so as to minimize an error from the desire profiles of the users (S1405).

$$E = {\sum }_{k , i} {( {R}_{log} ( {U}_{i} , {U}_{j} ) )}^{2} {\sum }_{i , j} {( {R}_{profile} ( {U}_{i} {U}_{j} ) )}^{2} \qquad ( 8 )$$

R_{log} (Uᵢ, Uⱼ) denotes a similarity in the action history, and R_{profile} (Uᵢ, Uⱼ) denotes a similarity of a calculated user profile. Other formulas can be used for the error function as long as the difference from the desire profile can be expressed.

The processes are repeated until the processes of S1403 and S1405 are minimized (S1403, S1404, S1405). The desire profiles of the users in which the desire profiles used in the calculation at the end of the minimization (S1406) are unknown and values for the basic desires in which the correspondence between the items and the basic desires is unknown are adopted (S1407). A genetic algorithm or a steepest descent method can be used as the minimization method.

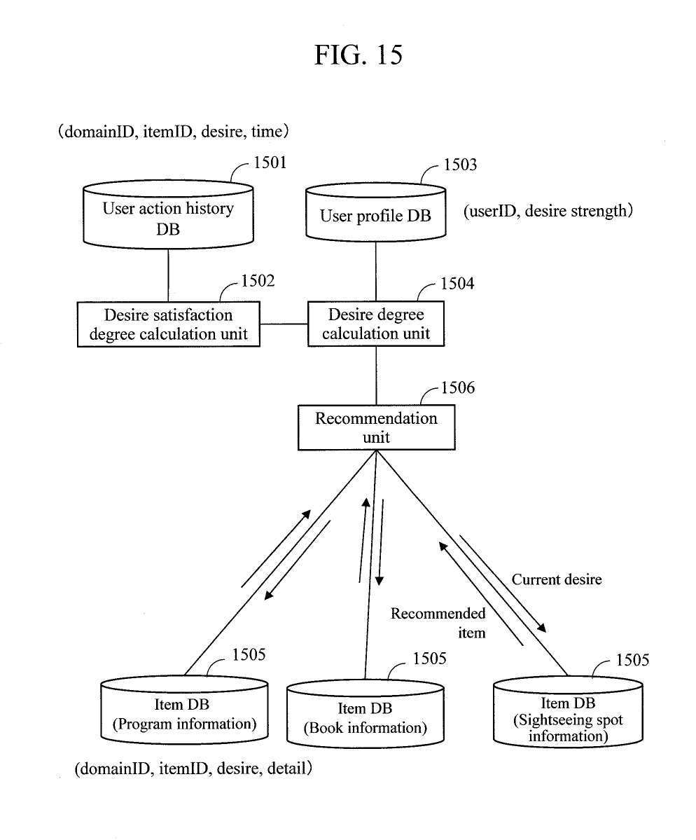

FIG. 15 is a system block diagram showing an example of configuration of an embodiment of the present invention including a plurality of item databases in different domains, and the system is a profile analysis system with a function of simultaneously recommending TV program information, book information, and sightseeing spot information. The system includes a user action history database 1501 that stores a viewing history of TV programs, a browsing history of books, a visiting history of sightseeing spots, etc., a desire satisfaction degree calculation unit 1502 that calculates a desire satisfaction degree from the user action history database 1501, a user profile database 1503 that stores information of constant desire degrees (strengths) of basic desires, a desire degree calculation unit 1504 that calculates current basic desire strengths from the desire satisfaction degree calculation unit 1502 and the user profile database 1503, a plurality of item databases 1505 each storing items, such as recommended TV program information, book information, and sightseeing spot information, and a recommendation unit 1506 that recommends items suitable for current basic desires of the user from the desire degree calculation unit 1504 and the plurality of item databases 1505.

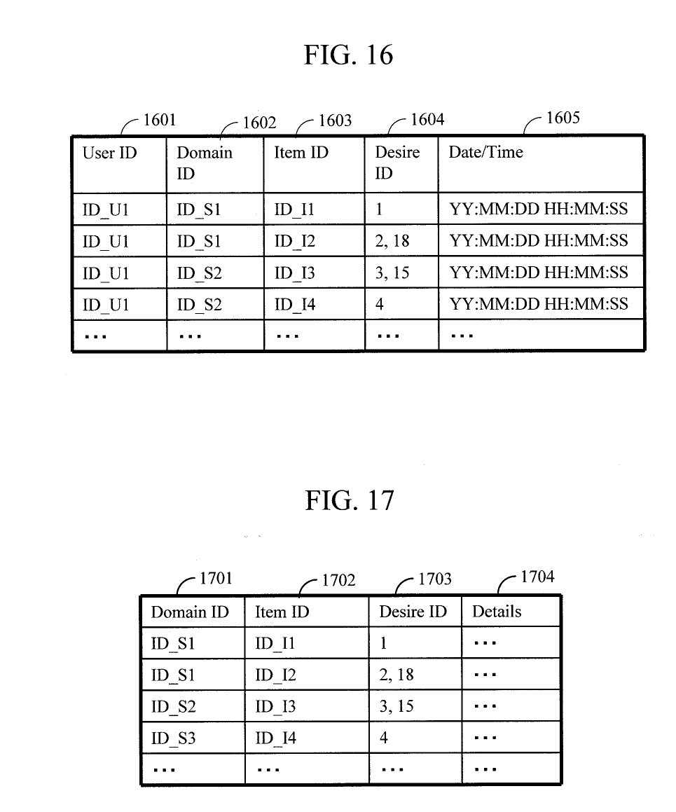

FIG. 16 is a diagram showing an example of data configuration of the user action history database 1501 according to the present embodiment. The diagram includes a user ID 1601 for uniquely identifying a user, a domain ID 1602 for uniquely identifying an individual domain, an item ID 1603 for uniquely identifying an item, a desire ID 1604 indicating the type of a basic desire, and date/time 1605 of the action by the user.

FIG. 17 is a diagram showing an example of configuration of data stored in the item database 1505 according to the present embodiment. The diagram includes a domain ID 1701 for uniquely identifying individual services, an item ID 1702 for uniquely identifying an item, a desire ID 1703 indicating the type of a basic desire, and details 1704 indicating details of the item by text.

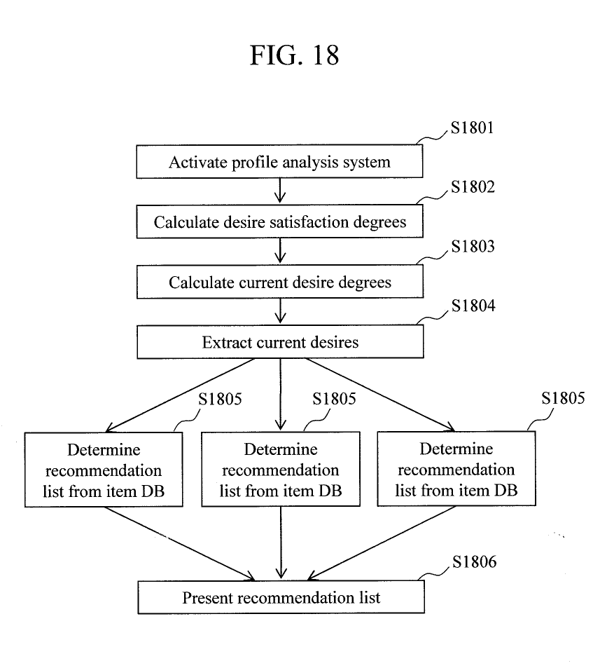

FIG. 18 is a flow chart showing an operation of the profile analysis system of the present embodiment. When the profile analysis system is activated (S1801), the desire satisfaction degree calculation unit 1502 calculates desire satisfaction degrees from all action history information (item selection history information) in different domains, such as the viewing history of TV programs, the browsing history of books, and the visiting history of sightseeing spots, stored in the user action history database 1501 (S1802). The desire satisfaction degrees can be calculated by Expression (1). The histories have different properties because the domains are different. However, since the actions are evaluated by the basic desires, it is obvious that the desire satisfaction degrees can be extracted based on the history information of different domains. The desire degree calculation unit 1504 calculates the current basic desire strengths based on the satisfaction degrees of the desire IDₙ and the constant desire degrees stored in the user profile database 1503 (S1803), and basic desires strongly desired by the user at this moment are extracted (S1804). The current basic desire strengths can be calculated by Expression (2). Lastly, items satisfying the basic desires extracted in S1804 are extracted from the item databases 1505 to determine items to be recommended (S1805), and the recommended items are presented to the user (S1806).

In the present embodiment, the items corresponding to the current basic desires can be searched from the plurality of item databases 1505 in different domains, and recommendation items corresponding to the current desires can be recommended to the user. For example, if the basic desire strongly desired at this moment determined in S1804 is “intellectual curiosity”, TV programs such as educational programs and quiz programs, books such as reference books and academic journals, and sightseeing spots such as plant tours and monument tours can be recommended at the same time.

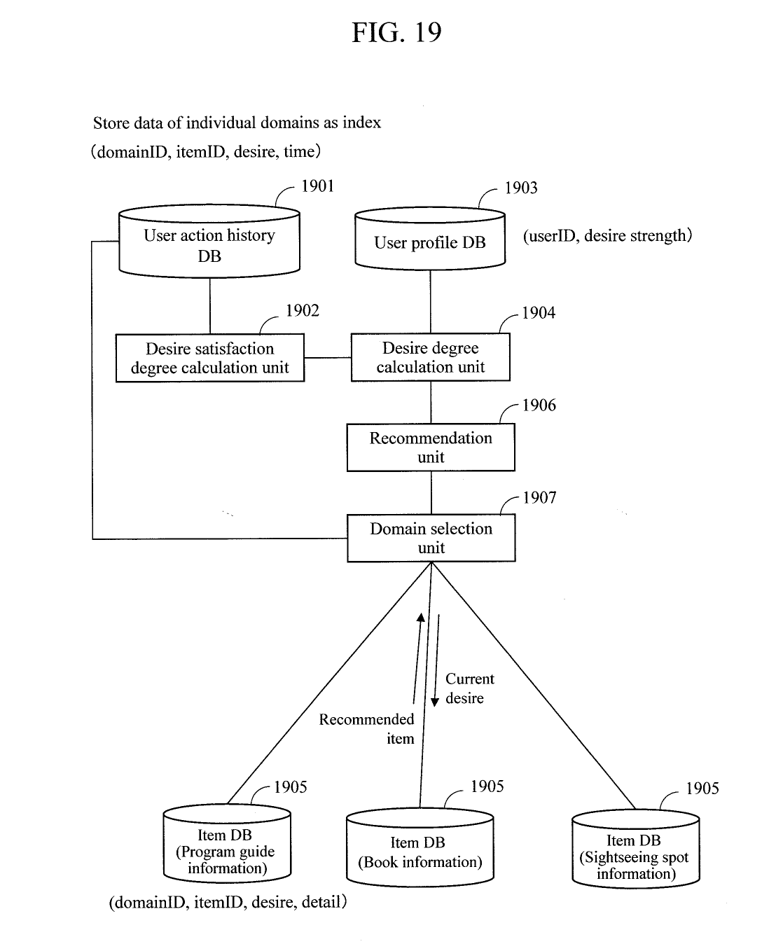

FIG. 19 is a diagram showing an example of system configuration of an embodiment with a function of determining whether domains can be used at the recommendation in the profile analysis system including item databases of a plurality of domains and determining the order of using the domains. The system includes a user action history database 1901 that stores a viewing history of TV programs, a browsing history of books, a visiting history of sightseeing spots, etc., a desire satisfaction degree calculation unit 1902 that calculates desire satisfaction degrees from the user action history database 1901, a user profile database 1903 that stores information of constant strengths of basic desires, a desire degree calculation unit 1904 that calculates current basic desire strengths from the desire satisfaction degree calculation unit 1902 and the user profile database 1903, a plurality of item databases 1905 that store item information such as TV program information, book information, and sightseeing spot information to be recommended, a recommendation unit 1906 that recommends items suitable for current basic desires of the user from the desire degree calculation unit 1904 and the item database 1905, and a domain selection unit 1907 that determines which item database will be used among the item databases in a plurality of domains. In general, basic desires as behavioral principles of human being that use the domain can be similar depending on the domain of the item. When all items of a plurality of domains shown in the block diagram of FIG. 15 are recommended, the recommendation of the most useful domain for the user may be buried in the recommendation of another domain, or the order of recommendation may be the last. The use of the system of the present embodiment can provide a result of recommendation of a more useful domain first.

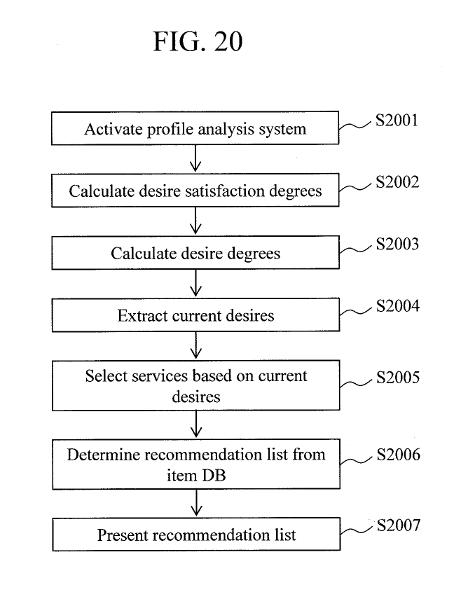

FIG. 20 is a flow chart showing a processing procedure of the present embodiment. When the profile analysis system is activated (S2001), the desire satisfaction degree calculation unit 1902 calculates the desire satisfaction degrees using all action history information in different domains, such as the viewing history of TV programs, the browsing history of books, and the visiting history of sightseeing spots, stored in the user action history database 1901 (S2002). The desire satisfaction degrees can be calculated by Expression (1). The desire degree calculation unit 1904 calculates the current basic desire strengths based on the satisfaction degrees of the desire IDₙ and the constant desire degrees stored in the user profile database 1903 (S2003), and basic desires strongly desired by the user at this moment are extracted (S2004). The current basic desire strengths can be calculated by Expression (2). The number of actions that have satisfied the target basic desire is compiled domain by domain from the user action history database 1901 to determine the domains in which more actions are performed (S2005). The action history used in the present step may be information specialized to the user in which only the action history of the target user is used, may be general information using the action histories of all users, or may be a combination. Lastly, items that satisfy the basic desires extracted in S2004 are determined from the item database 1905 of the domain selected in S2005 (S2006), and the recommended items are presented to the user (S2007).

Although the largest current desire is used to select the domain and items in the present embodiment, a plurality of basic desires may also be used. As for the determination of the domain, it is obvious that priorities can be set to the domains based on the number of actions and that part or all of the domains with higher priorities can be used, instead of just specifying one domain.

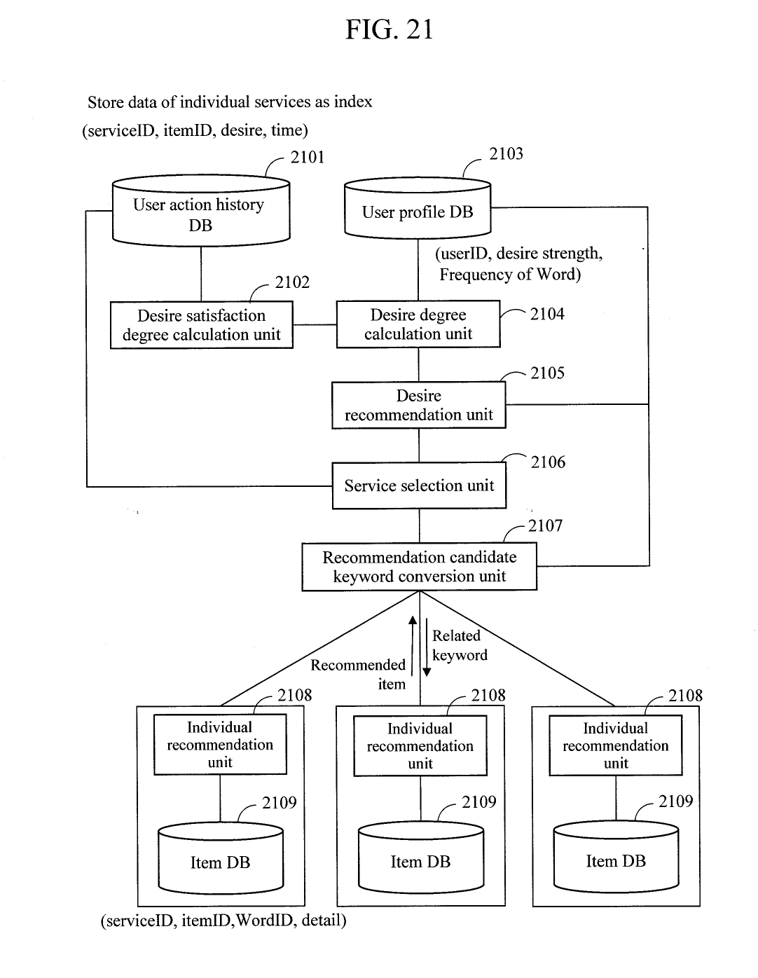

FIG. 21 is a block diagram showing an embodiment of applying the profile analysis system of the present invention to a recommendation service for providing various existing contents. The system includes a user action history database 2101 that stores action histories in the services, a desire satisfaction degree calculation unit 2102 that calculates desire satisfaction degrees from the user action history database 2101, a user profile database 2103 that stores constant desire strengths and appearance frequency information of keywords in items satisfying specific basic desires when individual services are used, a desire degree calculation unit 2104 that calculates current basic desire strengths from the desire satisfaction degree calculation unit 2102 and the user profile database 2103, a desire recommendation unit 2105 that selects basic desires used for recommendation from the basic desire strengths, a service selection unit 2106 that specifies services to be used from the recommended basic desires, a recommendation candidate keyword conversion unit 2107 that calculates search keywords based on the basic desires determined by the desire recommendation unit for individual services, an individual recommendation unit 2108 that recommends items to services based on specific conditions, and an item database 2109 including information of relationship between items included in the services and individual recommendation conditions. The profile analysis system has a function of connecting to existing services, such as a TV program recommendation service, a book sales service, and a tourist information service, and acquiring a result of recommendation.

Information for associating the items with the basic desires are not usually stored as an item database in the existing services, such as the TV program recommendation service, the food sales service, and the book sales service. Each individual service includes a specific individual recommendation unit 2108 and an individual item database 2109. In the present embodiment, keyword information in a form that can be adapted to individual recommendation systems of the individual services is calculated based on the basic desires calculated by the profile analysis system. The keywords are used to use the individual services.

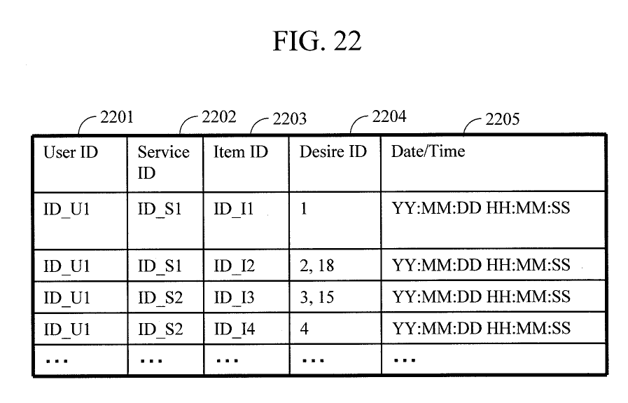

FIG. 22 is a block diagram of user action history data stored in the user action history database 2101, and the diagram includes a user ID 2201 that uniquely specifies the user, a service ID 2202 that specifies the connected service, an item ID 2203 that specifies the TV program information, the book information, the sightseeing spot information, etc., provided by various services, a desire ID 2204 indicating the basic desire that is satisfied when the action is performed or that has served as the behavioral principle of the action, and date/time 2205 of the action. The desire ID 2204 is stored in the item database. The item database learns the basic desire as a behavioral principle of the action based on the previous embodiments.

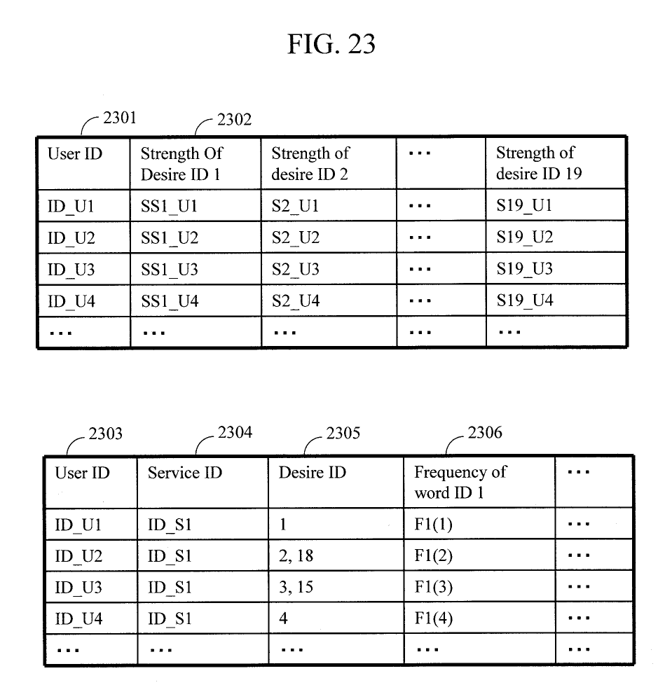

FIG. 23 is a block diagram showing appearance frequency information of search keywords selected when the desire profiles stored in the user profile database 2103 and the target service are used based on specific basic desires. The desire profile includes a user ID 2301 for specifying the user and a strength of desire IDₙ 2302 as information indicating the constant desire degree of each basic desire. The appearance frequency information of search keywords includes a user ID 2303 for specifying the user, a service ID 2304 for specifying the service, a desire 2305 as a behavioral principle of using the service, and an appearance frequency 2306 of a keyword as an input of the individual recommendation unit when the service is used based on the basic desire. The service provider may uniquely determine the information of each individual service, or the information may be created based on a questionnaire upon the subscription of the user. The values may be calculated using a frequency calculation system used to extract a feature word, such as tfidf, from the use history of the service.

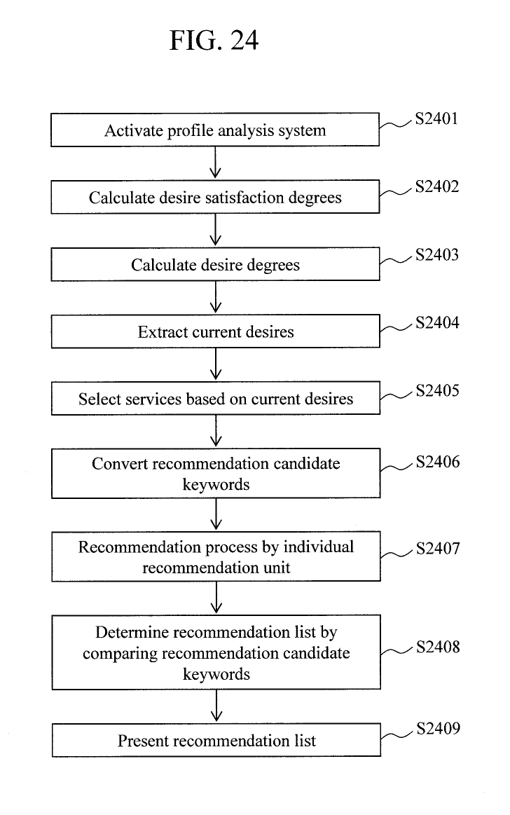

FIG. 24 is a flow chart of the present embodiment. When the profile analysis system is activated (S2401), the desire satisfaction degree calculation unit 2102 calculates the desire satisfaction degrees based on the desires stored in the user action history database 2101 (S2402). The desire degree calculation unit 2104 calculates the current basic desire strengths based on the satisfaction degrees of the desire ID, and the constant desire degrees stored in the user profile database 2103 (S2403) and extracts strong basic desires of the user (S2404). The services with the extracted basic desires are searched from the user action history database 2101 to specify the service to be used (S2405). Words with large values of the frequency 2306 of the word ID, are set as recommendation candidate keywords from the user profile database 2103 based on the basic desires extracted in S2404 and the service selected in S2405 (S2406). The process is then handed over to the individual recommendation unit 2108.

Meanwhile, the individual recommendation unit 2108 compares the search keywords stored in the item database 2109 held by the individual service with the recommendation candidate keywords to determine the items to be recommended (S2408), and the recommended items are presented to the user (S2409). Alternatively, the appearance frequencies of the words are used to calculate recommendation scores in accordance with, for example, the following formula to set the items with higher recommendation scores as the recommended items.

$$Score ( Item\_ID ) = \frac{1}{\vert P ( Item\_ID ) \vert} {\sum }_{i ∈ P ( Item\_ID )} Fi ( User\_ID ) \qquad ( 9 )$$

Score (Item_ID) denotes a recommendation score of an item with an item ID Item_ID, P (Item_ID) denotes a word group of an item with an item ID Item_ID, and |P (Item_ID)| denotes the number of words of P (Item_ID). Fi (User_ID) denotes a frequency of a word with a word ID i of a user with a user ID User_ID. Other systems may be used as the calculation system of the scores as long as the order of recommending the items can be determined.

Although the present embodiment illustrates an example of combinations of the item information, such as the TV program information, the book information, and the sightseeing spot information, and various recommendation services, it is obvious that the invention can be applied to functions of recommending items of various domains.

The present invention is not limited to the embodiments, and various modified examples are included. For example, the embodiments are described in detail to describe the present invention in an easily understood manner, and the embodiments are not necessarily limited to the embodiments including all configurations described above. Part of a configuration of an embodiment can be replaced by a configuration of another embodiment, and a configuration of another embodiment can be added to a configuration of an embodiment. Addition, deletion, and replacement of other configurations to part of a configuration of an embodiment are also possible.

The configurations, the functions, the processing units, the processing means, etc., can be realized by hardware such as by designing part or all of the components by an integrated circuit. A processor may interpret and execute programs for realizing the configurations, the functions, etc., to realize the functions by software. Information, such as programs, tables, and files, for realizing the functions may be placed on a recording device, such as a memory, a hard disk, and an SSD (Solid State Drive), or on a recording medium, such as an IC card, an SD card, and a DVD.

### DESCRIPTION OF SYMBOLS

101 . . . user action history database, 102 . . . desire satisfaction degree calculation unit, 103 . . . user profile database, 104 . . . desire degree calculation unit, 105 . . . item database, 106 . . . recommendation unit, 601 . . . user action history database, 602 . . . desire satisfaction degree calculation unit, 603 . . . user profile database, 604 . . . desire degree calculation unit, 605 . . . item database, 606 . . . recommendation unit, 607 . . . feedback processing unit, 801 . . . user action history database, 802 . . . user profile database, 803 . . . item database, 804 . . . desire analysis unit, 1201 . . . item table, 1202 . . . probability table, 1501 . . . user action history database, 1502 . . . desire satisfaction degree calculation unit, 1503 . . . user profile database, 1504 . . . desire degree calculation unit, 1505 . . . item database, 1506 . . . recommendation unit, 1901 . . . user action history database, 1902 . . . desire satisfaction degree calculation unit, 1903 . . . user profile database, 1904 . . . desire degree calculation unit, 1905 . . . item database, 1906 . . . recommendation unit, 1907 . . . domain selection unit, 2101 . . . user action history database, 2102 . . . desire satisfaction degree calculation unit, 2103 . . . user profile database, 2104 . . . desire degree calculation unit, 2105 . . . desire recommendation unit, 2106 . . . service selection unit, 2107 . . . recommendation candidate keyword conversion unit, 2108 . . . individual recommendation unit, 2109 . . . item database

What is claimed is:

1. A profile analysis system comprising:
a user action history database that stores information related to an item selection history of a user;
a user profile database that stores, as a desire profile of the user, information of constant desire strengths of the user for basic desires of a plurality of types;
an item database that stores information related to a correspondence between items and the types of the basic desires;
a desire satisfaction degree calculation unit that calculates desire satisfaction degrees for the basic desires of the user from the item selection history stored in the user action history database;
a desire calculation unit that calculates current basic desire strengths of the user from the desire satisfaction degrees and the desire profile; and
a recommendation unit that recommends items suitable for the current basic desire strengths of the user from the item database based on the current basic desire strengths of the user and the correspondence between the items and the types of the basic desires.

2. The profile analysis system according to claim 1, wherein
if the items recommended by the recommendation unit are not selected by the user, the desire profile of the user is modified to reduce the basic desire strengths corresponding to the items.

3. The profile analysis system according to claim 1, further comprising
a user profile learning unit that compiles the basic desires corresponding to the selected items by the types based on the item selection history of the user stored in the user action history database to calculate relative strengths of the basic desires to set the relative strengths as the desire profile of the user, wherein
if the correspondence between the items and the types of the basic desires is known and the desire profile of the user is unknown, the user profile learning unit learns the desire profile of the user.

4. The profile analysis system according to claim 1, further comprising:
means for clustering the items into a plurality of item sets according to similarities;
means for allocating the types of the basic desires to the clustered item sets;
means for calculating the desire profile of the user from the types of the basic desires allocated to the item sets and the item selection history of the user stored in the user action history database;
means for calculating a degree of adaptability between the calculated desire profile and a known desire profile of the user; and
means for adjusting the types of the basic desires allocated to the item sets to maximize the degree of adaptability, wherein
if the correspondence between the items and the types of the basic desires is unknown and the desire profile of the user is known, the types of the basic desires corresponding to the items are learned.

5. The profile analysis system according to claim 1, further comprising:
means for calculating similarities between items in which the correspondence with the types of the basic desires is known and items in which the correspondence is unknown;
means for setting the types of the basic desires of the items in which the correspondence is known as the types of the basic desires of the items in which the correspondence is unknown among the items with high similarities;
means for using the types of the basic desires set to the items in which the correspondence is unknown to compile the basic desires corresponding to the selected items by the types from the item selection history of the user in which the desire profile is known to calculate the relative strengths of the basic desires as the desire profile of the user and adjusting the types of the basic desires set to the items in which the correspondence is unknown to maximize the degree of adaptability between the calculated desire profile and the known desire profile; and
means for compiling the basic desires corresponding to the selected items by the types from the item selection history of the user in which the desire profile is unknown to calculate the relative strengths of the basic desires as the desire profile of the user, calculating the degree of adaptability between the desire profile of the user, in which the similarity of the item selection history with the user is high and the desire profile is known, and the calculated desire profile, and adjusting the types of the basic desires set to the items in which the correspondence is unknown to maximize the degree of adaptability, wherein
if the types of the basic desires corresponding to part of the items and the desire profiles of part of the users are known, the types of the basic desires for the items in which the correspondence with the types of the basic desires are unknown and the desire profiles of the users in which the desire profiles are unknown are learned.

6. The profile analysis system according to claim 1, further comprising
a plurality of item databases, wherein
the recommendation unit recommends the items suitable for the current basic desire strengths of the user from the plurality of item databases.

7. The profile analysis system according to claim 6, further comprising
selection means for selecting the item database corresponding to the desires from the current desire strengths and the desire profile stored in the action history database, wherein
the recommendation unit recommends the items suitable for the current basic desire strengths from the item database selected by the selection means.

8. A profile analysis system comprising:
a user action history database that stores information of items selected by a user, services that has provided the items, and basic desires related to the selection of the items;
a user profile database that stores a desire profile indicating constant desire strengths of the user for the basic desires of a plurality of types and information indicating a correspondence between the types of the basic desires and keywords for each service;
a desire satisfaction degree calculation unit that calculates desire satisfaction degrees for the basic desires of the user from the item selection history stored in the user action history database;
a desire calculation unit that calculates current basic desire strengths of the user from the desire satisfaction degrees and the desire profile;
a desire recommendation unit that selects strong basic desires of the user from a calculation result of the desire calculation unit;
a database selection unit that selects services to be used from the basic desires selected by the desire recommendation unit;
means for extracting the keywords from the user profile database based on the selected services and the basic desires selected by the desire recommendation unit;
transmission means for transmitting the extracted keywords as search keys to the database that provides the selected services; and
reception means for receiving the items transmitted as a search result from the database.
